(19) United States
(12) Patent Application Publication
(10) Pub. No.: US 2006/0015704 A1
(43) Pub. Date: Jan. 19, 2006

(54) Operation apparatus and instruction code executing method

(75) Inventors: Hiroyuki Osawa, Kanagawa (JP); Ryuji Ishida, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/179,579

(22) Filed: Jul. 13, 2005

(30) Foreign Application Priority Data
Jul. 14, 2004 (JP) 207717/2004

(51) Int. Cl. G06F 9/30

(52) U.S. Cl. 712/209

(57) ABSTRACT

An operation apparatus includes signal lines, a decoder connected with the signal lines and configured to sequentially decode first and second instruction codes on the signal lines, an instruction executing section configured to execute operation processing based on each of the decoding results of the first and second instruction codes by the decoder, respectively, and an output unit connected with the signal lines and configured to continuously and sequentially output the first and second instruction codes onto the signal lines. Each of the first and second instruction codes comprises a first bit data and a second bit data. The first bit data of the first instruction code indicates that the first instruction code belongs to a first one of instruction code groups and at least a portion of the second bit data of the first instruction code indicates an instruction content of the first instruction code. Also, the first bit data of the second instruction code indicates that the second instruction code belongs to a second one of the instruction code groups and at least a portion of the second bit data of the second instruction code is same as that of the second bit data of the first instruction code.

### BACKGROUND OF THE INVENTION

1. Field of the Invention

The present invention relates to an operation apparatus and a signal line control method.

2. Description of the Background Art

A computer includes a central processing unit (CPU) or an operation apparatus. The CPU includes an output unit, a bus, a decoder, and an instruction executing section. The output unit outputs an instruction code or a No-Operation (NOP) code to the decoder through the bus. The decoder decodes the instruction code on the bus and the instruction executing section executes the instruction code decoded by the decoder.

The instruction code or NOP code is configured of a plurality of bits. The instruction code is one of combinations of “1” and “0”, and represents a content of the instruction code. The NOP code is represented by bits of “0”, as shown in Data Book Signal Processing LSI (DSP/Voice), (NEC Corporation Edition, January 1996, pp. 25-36).

The bus includes a plurality of signal lines. When a first bit of the bits of the instruction code outputted onto the bus represents “1”, charge is stored in a first signal line of the signal lines of the bus. When the first bit of the bits of another instruction code outputted onto the bus represents “0”, the charge having been stored in the first signal line is discharged. In this way, the charge stored in the first signal line is changed from “1” to “0”, thereby consuming power for driving the bus.

It is assumed herein that the output unit of the CPU outputs the instruction code and the NOP code to the decoder through the bus in this order, and that ten bits of a plurality of bits of the instruction code outputted prior to the NOP code represent “1”. Since a plurality of bits of the NOP code all represent “0”, charges stored in the signal lines corresponding to the ten bits are changed from “1” to “0”. Thus, the operation apparatus consumes power even if the output unit outputs the NOP code to the decoder through the bus.

Recently, in many computers, a multi-stage pipeline is used to execute an instruction at high speed. Thus, necessity for providing an NOP code between instruction codes rises so as to ensure the pipeline processing to an instruction execution procedure, a branch instruction, or the like.

### SUMMARY OF THE INVENTION

Therefore, an object of the present invention is to provide an operation apparatus and an instruction code executing method, in which power consumption required to drive signal lines can be reduced.

In an aspect of the present invention, an operation apparatus includes signal lines, a decoder connected with the signal lines and configured to sequentially decode first and second instruction codes on the signal lines, an instruction executing section configured to execute operation processing based on each of the decoding results of the first and second instruction codes by the decoder, respectively, and an output unit connected with the signal lines and configured to continuously and sequentially output the first and second instruction codes onto the signal lines. Each of the first and second instruction codes comprises a first bit data and a second bit data. The first bit data of the first instruction code indicates that the first instruction code belongs to a first one of instruction code groups and at least a portion of the second bit data of the first instruction code indicates an instruction content of the first instruction code. Also, the first bit data of the second instruction code indicates that the second instruction code belongs to a second one of the instruction code groups and at least a portion of the second bit data of the second instruction code is same as that of the second bit data of the first instruction code.

Here, the output unit may include a memory configured to store a plurality of original instruction codes. Continuous two of the plurality of original instruction codes are sequentially outputted from the memory as first and second original instruction codes. When the first original instruction code belongs to the first instruction code group, the first instruction code is outputted from the output unit onto the signal lines to have the first bit data and the second bit data of the first original instruction code. Also, when the second original instruction code belongs to the second instruction code group, the second instruction code is outputted from the output unit onto the signal lines to have the first bit data of the second original instruction code and the second bit data of the first original instruction code.

In this case, the first bit data may be a 1-bit data. The output unit may include the memory; a selector; and a holding section configured to hold the second bit data outputted from the selector. The selector may select one of the second bit data of each of the plurality of original instruction codes from the memory and the second bit data held by the holding section in response to the first bit data of the each original instruction code from the memory, and output the selected second bit data to the holding section. That is, the selector may select the second bit data of the first original instruction code in response to the first bit data of the first original instruction code and output the selected second bit data to the holding section; and may select the second bit data held by the holding section in response to the first bit data of the second original instruction code and output the selected second bit data to the holding section. Thus, the first bit data of the first original instruction code and the selected second bit data are outputted to the signal lines as the first instruction code, and the first bit data of the second original instruction code and the selected second bit data are outputted to the signal lines as the second instruction code.

The second original instruction code may be a No Operation code.

Also, the output unit may include a memory configured to store a plurality of instruction codes. Continuous two of the plurality of instruction codes may be sequentially outputted from the memory as first and second instruction codes.

Also, the second bit may include a first bit portion and a second bit portion. The output unit may include a memory configured to store a plurality of original instruction codes. Continuous two of the plurality of original instruction codes are sequentially outputted from the memory as first and second original instruction codes. When the first original instruction code belongs to the first instruction code group, the first instruction code is outputted from the output unit onto the signal lines to have the first bit data, the first bit portion and the second bit portion of the first original instruction code. Also, when the second original instruction code belongs to the second instruction code group, the second instruction code is outputted from the output unit onto the signal lines to have the first bit data and the first bit portion of the second original instruction code and the second bit portion of the first original instruction code.

In this case, the first bit data may be a plural bit data. The output unit may include the memory; a decoding section configured to decode each of the plurality of original instruction codes; first and second selectors; and first and second holding section configured to hold the first and second bit potions outputted from the first and second selectors, respectively. The decoding section may decode the first bit data of each of the first and second original instruction codes. The first selector may select one of the first bit portion of each of the plurality of original instruction codes from the memory and the first bit portion held by the first holding section in response to the decoding result of the first bit data of the original instruction code from the memory, and output the selected first bit portion to the first holding section. Also, the second selector may select one of the second bit portion of the original instruction code and the second bit portion held by the second holding section in response to the decoding result of the first bit data of the original instruction code, and output the selected second bit portion to the second holding section. That is, the first selector selects the first bit portion of the first original instruction code in response to the decoding result of the first bit data of the first original instruction code and outputs the selected first bit portion to the first holding section; and selects the first bit portion of the second original instruction code in response to the decoding result of the first bit data of the second original instruction code and outputs the selected first bit portion to the first holding section. The second selector selects the second bit portion of the first original instruction code in response to the decoding result of the first bit data of the first original instruction code and outputs the selected second bit portion to the second holding section; and selects the second bit portion held by the second holding section in response to the first bit data of the second original instruction code and outputs the selected second bit data to the second holding section. Thus, the first bit data and the first bit portion of the first original instruction code and the selected second bit portion are outputted to the signal lines as the first instruction code, and the first bit data and the first bit portion of the second original instruction code and the selected second bit portion are outputted to the signal lines as the second instruction code.

In another aspect of the present invention, a method of executing instruction codes, is achieved by continuously and sequentially outputting first and second instruction codes onto signal lines; by decoding each of the first and second instruction codes on the signal lines; and by executing operation processing based on the decoding result of each of the first and second instruction codes. Each of the first and second instruction codes comprises a first bit data and a second bit data. The first bit data of the first instruction code indicates that the first instruction code belongs to a first one of instruction code groups and at least a portion of the second bit data of the first instruction code indicates an instruction content of the first instruction code. The first bit data of the second instruction code indicates that the second instruction code belongs to a second one of the instruction code groups and at least a portion of the second bit data of the second instruction code has a same second bit data as that of the second bit data of the first instruction code.

Here, the continuously and sequentially outputting first and second instruction codes may be achieved by outputting a plurality of original instruction codes from a memory, wherein continuous two of the plurality of original instruction codes are sequentially outputted from the memory as first and second original instruction codes; by outputting the first instruction code onto the signal lines to have the first bit data and the second bit data of the first original instruction code when the first original instruction code belongs to the first instruction code group; and by outputting the second instruction code onto the signal lines to have the first bit data of the second original instruction code and the second bit data of the first original instruction code when the second original instruction code belongs to the second instruction code group.

In this case, when the first bit data is a 1-bit data, the outputting the first instruction code may be achieved by selecting the second bit data of the first original instruction code in response to the first bit data of the first original instruction code; by holding the selected second bit data of the first original instruction code; and by outputting the first bit data of the first original instruction code and the selected second bit data to the signal lines as the first instruction code. Also, the outputting the second instruction code may be achieved by selecting the held second bit data in response to the first bit data of the second original instruction code; and by outputting the first bit data of the second original instruction code and the selected second bit data to the signal lines as the second instruction code.

The second original instruction code may be a No Operation code.

Also, the continuously and sequentially outputting first and second instruction codes may be achieved by storing a plurality of instruction codes in a memory; and by reading out continuous two of the plurality of instruction codes sequentially as first and second instruction codes.

Also, when the second bit comprises a first bit portion and a second bit portion, the continuously and sequentially outputting first and second instruction codes may be achieved by outputting a plurality of original instruction codes from a memory configured, wherein continuous two of the plurality of original instruction codes are sequentially outputted from the memory as first and second original instruction codes; by outputting the first instruction code onto the signal lines to have the first bit data, the first bit portion and the second bit portion of the first original instruction code, when the first original instruction code belongs to the first instruction code group; and by outputting the second instruction code onto the signal lines to have the first bit data and the first bit portion of the second original instruction code and the second bit portion of the first original instruction code, when the second original instruction code belongs to the second instruction code group.

Also, when the first bit data is a plural bit data, the outputting the first instruction code may be achieved by decoding the first bit data of the first original instruction code; by selecting the first bit portion of the first original instruction code in response to the decoding result of the first bit data of the first original instruction code; by selecting the second bit portion of the first original instruction code in response to the decoding result of the first bit data of the first original instruction code; by holding the selected first bit portion; by holding the selected second bit portion; and by outputting the first bit data and the first bit portion of the first original instruction code and the selected second bit portion to the signal lines as the first instruction code. Also, the outputting the second instruction code may be achieved by decoding the first bit data of the second original instruction code; by selecting the first bit portion of the second original instruction code in response to the decoding result of the first bit data of the second original instruction code; by selecting the held second bit portion held by the second holding section in response to the first bit data of the second original instruction code; and by outputting the first bit data and the first bit portion of the second original instruction code and the selected second bit portion onto the signal lines as the second instruction code.

In another aspect of the present invention, a computer-readable software product contains codes for realizing a method of executing instruction codes. The method may include continuously and sequentially outputting first and second instruction codes onto signal lines; decoding each of the first and second instruction codes on the signal lines; and executing operation processing based on the decoding result of each of the first and second instruction codes. Each of the first and second instruction codes comprises a first bit data and a second bit data. The first bit data of the first instruction code indicates that the first instruction code belongs to a first one of instruction code groups and at least a portion of the second bit data of the first instruction code indicates an instruction content of the first instruction code. The first bit data of the second instruction code indicates that the second instruction code belongs to a second one of the instruction code groups and at least a portion of the second bit data of the second instruction code has a same second bit data as that of the second bit data of the first instruction code.

### BRIEF DESCRIPTION OF THE DRAWINGS

FIG. 1 is a block diagram showing a configuration of an operation apparatus according to a first embodiment of the present invention;

FIG. 2 is a table showing instruction codes stored in an instruction memory of an output unit contained in the operation apparatus according to the first embodiment of the present invention;

FIG. 3 is a flowchart showing an operation carried out by an instruction output section of the output unit contained in the operation apparatus according to the first embodiment of the present invention;

FIG. 4 is a block diagram showing a configuration of the operation apparatus according to a second embodiment of the present invention;

FIG. 5 is a table showing instruction codes described in a computer program stored in an instruction memory of an output unit contained in the operation apparatus according to the second embodiment of the present invention;

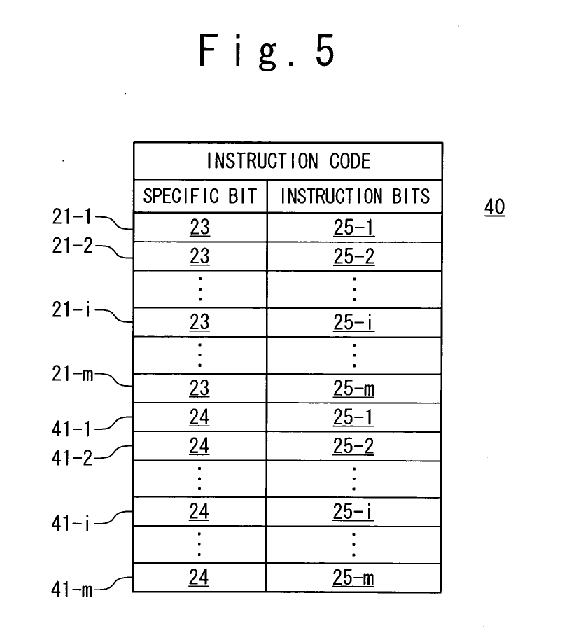

FIG. 6 is a flowchart showing an operation performed by the output unit contained in the operation apparatus according to the second embodiment of the present invention; and

FIG. 7 is a block diagram showing a configuration of the operation apparatus according to a third embodiment of the present invention.

### DESCRIPTION OF THE PREFERRED EMBODIMENTS

Hereinafter, an operation apparatus according to the present invention will be described in detail with reference to the accompanying drawings.

### First Embodiment

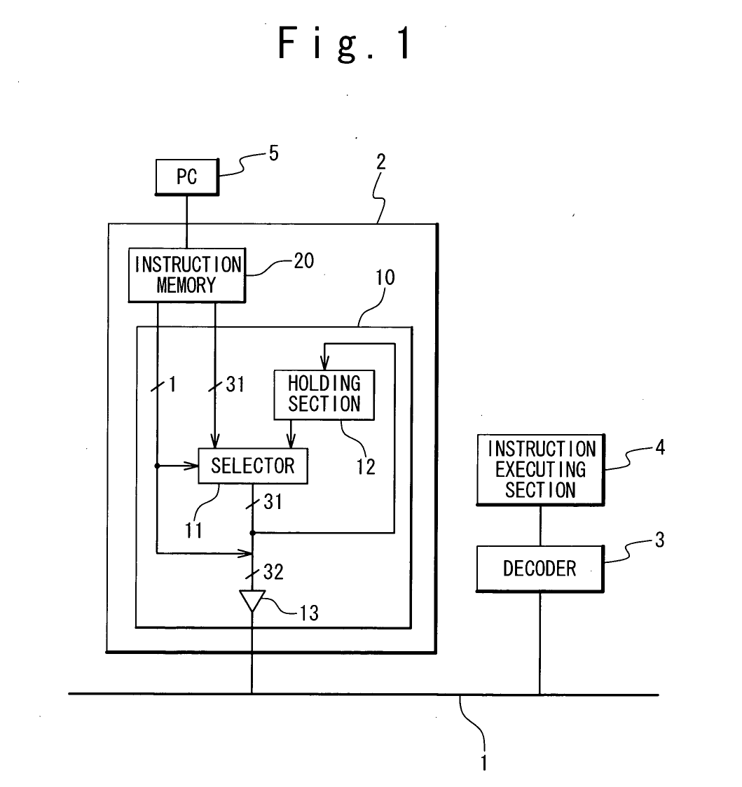

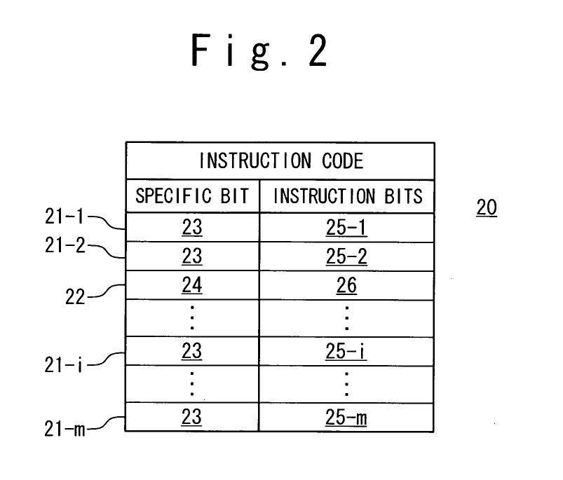

FIG. 1 is a block diagram showing a configuration of the operation apparatus according to the first embodiment of the present invention. The operation apparatus according to the first embodiment includes a bus 1, an output unit 2, a decoder 3, an instruction executing section 4, and a program counter (PC) 5. An output unit 2 and a decoder 3 are connected with the bus 1. The program counter 5 is connected to the output unit 2, and the instruction executing section 4 is connected with the decoder 3. The output unit 2 includes an instruction memory 20 and an instruction output section 10. As shown in FIG. 2, m (where m is an integer equal to or greater than 1) instruction codes 21-1 to 21-m and instruction code 22 are stored in the instruction memory 20.

The instruction code 21-i (where i=1, 2, . . . , m) is an instruction code outputted from the output unit 2 to the decoder 3 through the bus 1. The instruction code 21-i is configured of a plurality of bits, e.g., 8 bits, 16 bits, 32 bits, or 64 bits. In this embodiment, it is assumed that the instruction code 21-i is configured of 32 bits. The instruction code 21-i includes at least one specific bit 23 representing an instruction code other than an NOP (no operation) code and instruction bits 25-i representing contents of the instruction code 21-i. In this embodiment, it is assumed that the specific bit 23 is a most significant bit and that the most significant bit is represented by “1”.

The instruction code 22 is an instruction code converted into an NOP code and outputted to the decoder 3 through the bus 1 by the output unit 2. The instruction code 22 is configured of a plurality of bits, e.g., eight bits, 16 bits, 32 bits, or 64 bits. In this embodiment, it is assumed that the instruction code 22 is configured of 32 bits. The instruction code 22 includes at least one specific bit 24 representing the NOP code and instruction bits 26 representing “Don't care”. In this embodiment, it is assumed that the specific bit 24 is the most significant bit and that the most significant bit is represented by “0”.

The bus 1 includes a plurality of signal lines. If the instruction code 21-i or 22 is configured of 32 bits, the bus 1 includes 32 signal lines. The respective 32 bits of the instruction code correspond to the 32 signal lines.

The program counter 5 outputs an instruction read command to read the instruction code stored in the instruction memory 20. If the instruction code 21-1 is to be read, a first instruction read command is transmitted from the program counter 5 to the instruction memory 20. At this time, the instruction code 21-1 is outputted from the instruction memory 20 to the instruction output section 10 in response to the first instruction read command. If the instruction code 22 is to be read, a second instruction read command is transmitted from the program counter 5 to the instruction memory 20. AT this time, the instruction code 22 is outputted from the instruction memory 20 to the instruction output section 10 in response to the second instruction read command.

The instruction output section 10 receives the instruction code 21-1 read out from the instruction memory 20. At this time, the instruction output section 10 outputs the instruction code 21-1 to the decoder 3 through the bus 1 based on the specific bit 23 of “1” contained in the instruction code 21-1. The output instruction code 21-1 is the same as the instruction code which the instruction output section 10 receives from the instruction memory 20, and includes the specific bit 23 of “1” and the instruction bits 25-1.

When the instruction output section 10 receives the instruction code 22 read out from the instruction memory 20, the instruction output section 10 outputs the NOP code to the decoder 3 through the bus 1 based on the specific bit 24 of “0” contained in the instruction code 22. The outputted NOP code includes the specific bit 24 of “0” and the instruction bits 25-1 contained in the instruction code 21-1.

The decoder 3 receives the instruction code 21-1 outputted from the instruction output section 10, and recognizes that the instruction code outputted from the instruction output section 10 is one of codes other than the NOP code based on the specific bit 23 of “1” contained in the instruction code 21-1. The decoder 3 decodes the instruction code 21-1 according to the instruction bits 25-1 contained in the instruction code 21-1. The instruction executing section 4 executes the instruction code 21-1 decoded by the decoder 3. The decoder 3 then receives the NOP code outputted from the instruction output section 10, and recognizes that the instruction code outputted from the instruction output section 10 is the NOP code based on the specific bit 24 of “0” contained in the NOP code. The decoder 3 allows the instruction executing section 4 to perform an operation corresponding to the NOP code.

It is assumed that ten bits of the instruction bits 25-1 contained in the instruction code 21-1 represent “1”. In addition, the specific bit 23 contained in the instruction code 21-1 represents “1”. As a result, when the instruction code 21-1 is outputted onto the bus 1, charges are stored on eleven signal lines of the 32 signal lines of the bus 1. The NOP code outputted onto the bus 1 next to the instruction code 21-1 includes the specific bit 24 and the instruction bits 25-1 outputted onto the bus 1 immediately before the NOP code. Therefore, when the NOP code is outputted onto the bus 1, only the charge stored on the first signal line corresponding to the most significant bit of the 32 signal lines contained in the bus 1 is discharged. That is, only the charge stored on the first signal line is changed from “1” to “0”.

If the ten bits of the instruction bits 25-1 contained in the instruction code 21-1 or NOP code represent “1”, the power consumption required to drive the bus 1 is reduced as compared with a case where all the bits contained in the NOP code all represent “0”. Therefore, the operation apparatus according to the first embodiment of the present invention can advantageously reduce power consumption as compared with the conventional operation apparatus when the number of bits representing “1” is larger among the instruction bits 25-1 contained in the instruction code 21-1 or NOP code.

As shown in FIG. 1, the instruction output section 10 includes a selector 11, a holding section 12 as a latch, and a buffer 13. The buffer 13 is connected to the bus 1.

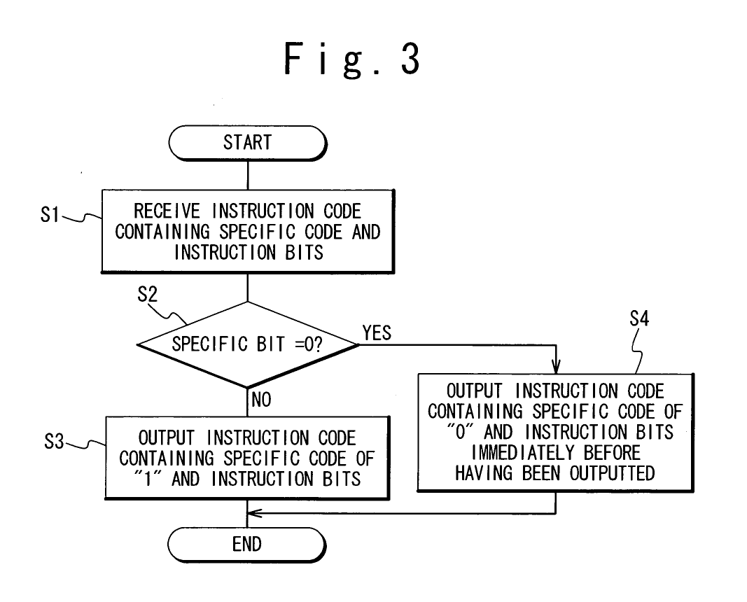

Next, referring to FIG. 3, an operation of the instruction output section 10 of the operation apparatus according to the first embodiment of the present invention will be described.

The instruction code 21-1 is read out from the instruction memory 20 in response to the first instruction read command. At this time, the selector 11 receives the specific bit 23 and the instruction bits 25-1 contained in the instruction code 21-1. In addition, the buffer 13 receives the specific bit 23 contained in the instruction code 21-1 at a step S1.

The specific bit 23 received by the selector 11 represents “1”. Namely, the specific bit 23 represents the instruction code other than the NOP code (“NO” at a step S2). In this case, the selector 11 outputs the received instruction bits 25-1 to the buffer 13 and the holding section 12. The holding section 12 holds or latches the instruction bits 25-1 outputted from the selector 11. The buffer 13 outputs the instruction code 21-1 containing the received specific bit 23 of “1” and the instruction bits 25-1 outputted from the selector 11 to the decoder 3 through the bus 1 (at a step S3). The decoder 3 decodes the instruction code 21-1 and the instruction executing section 4 executes the instruction code 21-1 decoded by the decoder 3.

Next, the instruction code 22 is read out from the instruction memory 20 in response to the second instruction read command. At this time, the selector 11 receives the specific bit 24 and the instruction bits 26 contained in the instruction code 22. In addition, the buffer 13 receives the specific bit 24 contained in the instruction code 22 at the step S1. The specific bit 24 received by the selector 11 represents “0”. Namely, the specific bit 24 represents the NOP code (“YES” at the step S2). In this case, the selector 11 selects the instruction bits 25-1 held in the holding section 12, and outputs the instruction bits 25-1 from the holding section to the buffer 13 and the holding section 12. The holding section 12 latches and holds the instruction bits 25-1 outputted from the selector 11. The buffer 13 outputs the NOP code containing the received specific bit 24 “0” and the instruction bits 25-1 outputted from the selector 11 to the decoder 3 through the bus 1 at a step S4. The decoder 3 allows the instruction executing section 4 to execute the operation corresponding to the NOP code.

As described above, in the operation apparatus according to the first embodiment of the present invention, the output unit 2 outputs the instruction code 21-1 and the NOP code to the decoder 3 through the bus 1 in this order. The instruction code 21-1 contains the specific bit 23 representing the instruction code other than the NOP code, and the instruction bits 25-1 representing the content of the instruction code 21-1. The NOP code contains the specific bit 24 representing the NOP code and the same instruction bits 25-1 as the instruction bits contained in the instruction code 21-1. As a result, when the NOP code is outputted onto the bus 1, only the charge stored in the signal line corresponding to the specific bit is changed among the signal lines contained in the bus 1. Thus, the operation apparatus according to the first embodiment of the present invention can reduce the power consumption required when driving the signal lines of the bus 1.

### Second Embodiment

In the operation apparatus according to the second embodiment of the present invention, the function of the output unit 2 in the first embodiment is achieved in software. In this case, an instruction code and an NOP code outputted next to the instruction code are generated in advance by a compiler or an assembler. In this way, the operation apparatus according to the second embodiment of the present invention does not necessitate the instruction output section 10 to latch the instruction bits 25-i and, therefore, can be configured in a small size as compared with the operation apparatus according to the first embodiment.

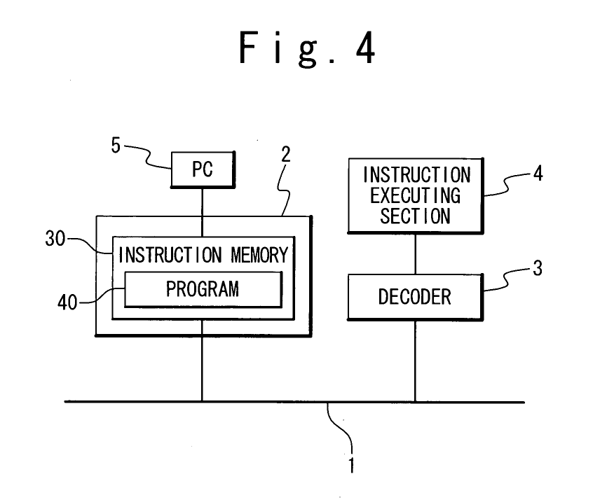

FIG. 4 is a block diagram showing a configuration of the operation apparatus according to the second embodiment of the present invention. The operation apparatus according to the second embodiment includes the bus 1, the output unit 2, the decoder 3, the instruction executing section 4, and the program counter (PC) 5. The output unit 2 and the decoder 3 are connected to the bus 1. The program counter 5 is connected to the output unit 2, and the instruction executing section 4 is connected to the decoder 3. The output unit 2 includes an instruction memory 30. The instruction memory 30 stores a set of instructions (program) 40. The output unit 2 operates according to the program 40. As shown in FIG. 4, in the program 40, m (where m is an integer equal to or greater than 2) instruction codes 21-1 to 21-m and m NOP codes 41-1 to 41-m are described.

The instruction code 21-i (where i=1, 2, . . . , m) is an instruction code outputted by the output unit 2 to the decoder 3 through the bus 1. The instruction code 21-i is configured of a plurality of bits, e.g., eight bits, 16 bits, 32 bits, or 64 bits. In this embodiment, it is assumed that the instruction code 21-i is configured of 32 bits. The instruction code 21-i contains the specific bit 23 representing an instruction code other than an NOP code and instruction bits 25-i representing a content of the instruction code 21-i. The specific bit 23 represents at least one of bits contained in the instruction code 21-i, and the instruction bits 25-i represent bits other than the specific bit 23. In this embodiment, it is assumed that the specific bit 23 is the most significant bit and that the most significant bit is represented by “1”.

The NOP code 41-i (where i=1, 2, . . . , m) is an NOP code outputted to the decoder 3 through the bus 1 by the output unit 2 next to the instruction code 21-1. The NOP code 41-i is configured of a plurality of bits, e.g., eight bits, 16 bits, 32 bits, or 64 bits. In this embodiment, it is assumed that the NOP code 41-i is configured of 32 bits. The NOP code 41-i includes a specific bit 24 representing the NOP code and instruction bits 25-i, which are same as the instruction bits contained in the instruction code 21-i. The specific bit 24 represents at least one of bits contained in the instruction code 22, and the instruction bits 25-i represent bits other than the specific bit 24. In this embodiment, it is assumed that the specific bit 24 is the most significant bit and that the most significant bit is represented by “0”.

The bus 1 includes a plurality of signal lines. When the instruction code 21-i or 22 is configured of 32 bits, the bus 1 includes 32 signal lines. Each of the respective 32 bits of the instruction code corresponds to one of 32 signal lines.

The program counter 5 outputs an instruction read command to read the instruction code stored in the instruction memory 20. If the instruction code 21-1 is to be read, a first instruction read command is transmitted from the program counter 5 to the instruction memory 30. At this time, one 21-1 of the instruction codes of the program 40 stored in the instruction memory 30 is outputted to the decoder 3 through the bus 1 in response to the first instruction read command. If the NOP code is then to be read, a second instruction read command is transmitted from the program counter 5 to the instruction memory 20. At this time, one 41-1 of the NOP codes of the program 40 stored in the instruction memory 30 the NOP code next to the instruction code 21-1 is outputted to the decoder 3 through the bus 1 in response to the second instruction read command.

The decoder 3 receives the instruction code 21-1 outputted from the instruction memory 30, and recognizes that the instruction code outputted from the instruction memory 30 is the code other than the NOP code based on the specific code 23 of “1” contained in the instruction code 21-1. The decoder 3 decodes the instruction code 21-1 according to the instruction bits 25-1 contained in the instruction code 21-1. The instruction executing section 4 executes the instruction code 21-1 decoded by the decoder 3.

The decoder 3 then receives the NOP code 41-1 outputted from the instruction memory 30, and recognizes that the instruction code outputted from the instruction memory 30 is the NOP code based on the specific bit 24 of “0” contained in the NOP code 41-1. The decoder 3 allows the instruction executing section 4 to execute an operation corresponding to the NOP code 41-1.

It is assumed herein that among the instruction bits 25-1 contained in the instruction code 21-1, ten bits represent “1”. Also, it is assumed that the specific bit 23 contained in the instruction code 21-1 represents “1”. In this case, when the instruction code 21-1 is outputted onto the bus 1, charges are stored in eleven signal lines of 32 signal lines of the bus 1.

When the NOP code 41-1 is outputted onto the bus 1 next to the instruction code 21-1, the NOP code 41-1 contains the specific bit 24 and the instruction bits 25-1 outputted onto the bus 1 just before the NOP code. Thus, when the NOP code 41-1 is outputted onto the bus 1, only the charge stored in the first signal line of the 32 signal lines corresponding to the most significant bit is discharged (only the charge stored in the first signal line is changed from “1” to “0”).

If the ten bits of the instruction bits 25-1 contained in the instruction code 21-1 or the NOP code 41-1 represent “1”, the power consumption required to drive the bus 1 is reduced as compared with a case where all the bits contained in the NOP code represent “0”. Therefore, the operation apparatus according to the second embodiment of the present invention can advantageously reduce power consumption as compared with the conventional operation apparatus, if the number of bits representing of “1” is larger among the instruction bits 25-1 contained in the instruction code 21-1 or the NOP code 41-1.

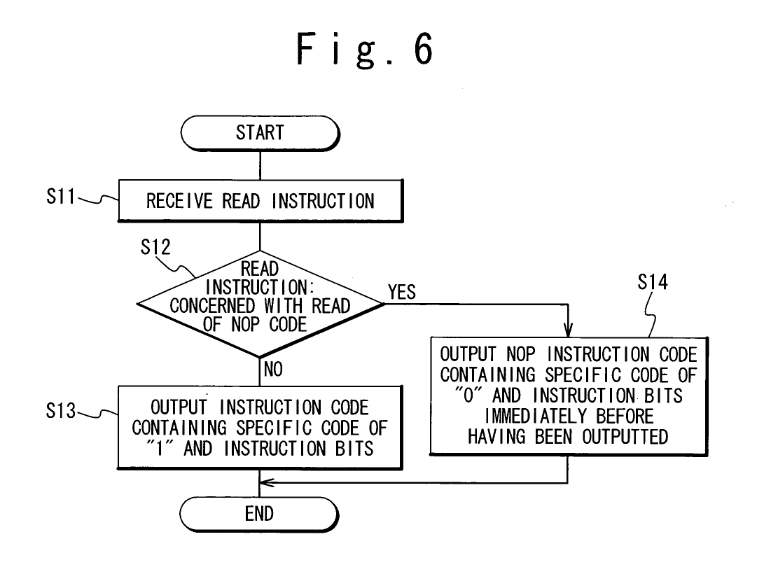

Next, referring to FIG. 6, an operation carried out by the output unit 2 of the operation apparatus according to the second embodiment of the present invention will be described.

The first one of the instruction codes of the program 40 stored in the instruction memory 30 receives the first instruction read command from the program counter 5 (in a step S11). The first instruction code is not the NOP code but the instruction code 21-1 (“NO” at a step S12). In this case, the instruction memory 30 outputs the instruction code 21-1 including the specific bit 23 of “1” and the instruction bits 25-1 to the decoder 3 through the bus 1 (in a step S13). The decoder 3 decodes the instruction code 21-1, and the instruction executing section 4 executes the instruction code 21-1 decoded by the decoder 3.

The instruction memory 30 then receives a second instruction read command from the program counter 5 at a step S11. The second instruction read command received by the instruction memory 30 represents an instruction read command to read the NOP code (“YES” at a step S12). In this case, the instruction memory 30 recognizes that the NOP code is the NOP code outputted after the instruction code 21-1, and outputs the NOP code 41-1 including the specific bit 24 of “0” and the instruction bits 25-1 to the decoder 3 through the bus 1 (at a step S14). The decoder 3 allows the instruction executing section 4 operating to correspond to the NOP code 41-1.

As described above, in the operation apparatus according to the second embodiment of the present invention, the output unit 2 outputs the instruction code 21-1 and the NOP code 41-1 to the decoder 3 through the bus 1 in this order. The instruction code 21-1 contains the specific bit 23 representing the instruction code other than the NOP code, and the instruction bits 25-1 representing the content of the instruction code 21-1. The NOP code 41-1 contains the specific bit 24 representing the NOP code and the same instruction bits 25-1 as the instruction bits contained in the instruction code 21-1. Thus, when the NOP code 41-1 is outputted onto the bus 1, only the charge stored in the signal line corresponding to the specific bit is changed among the signal lines contained in the bus 1. Therefore, the operation apparatus according to the second embodiment of the present invention can reduce the power consumption required to drive the signal lines of the bus 1.

Further, the operation apparatus according to the second embodiment can realize the output unit 2 of the operation apparatus according to the first embodiment in software. Thus, the operation apparatus according to the second embodiment of the present invention does not necessitate the instruction output section 10 that latches the instruction bits 25-i and can reduce a size as compared with the operation apparatus according to the first embodiment.

### Third Embodiment

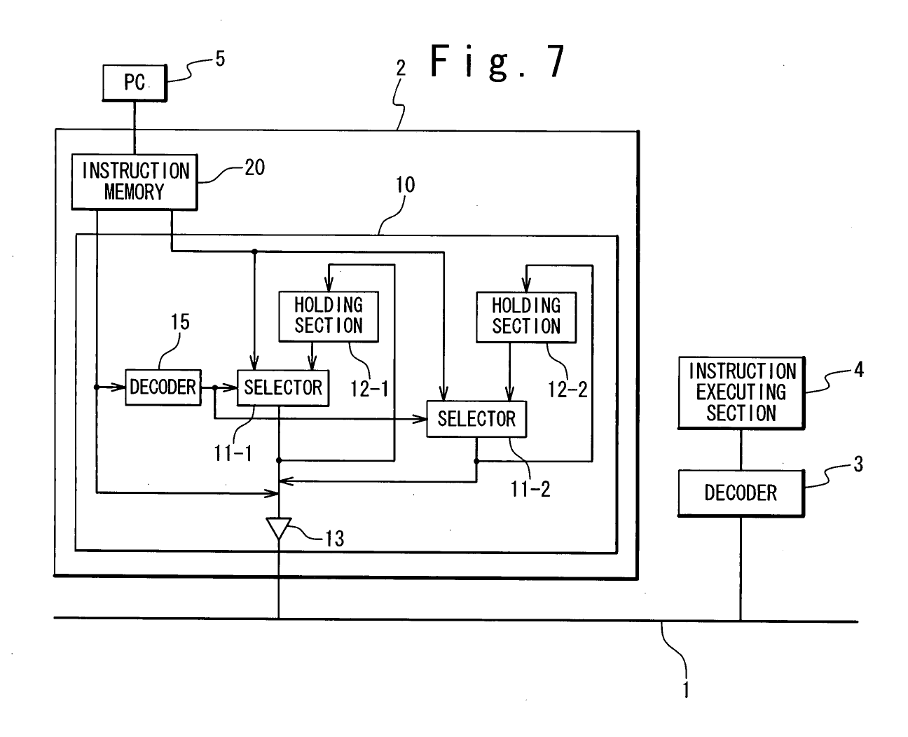

Next, the operation apparatus according to the third embodiment of the present invention will be described with reference to FIG. 7. In the first and second embodiment, the instruction codes are grouped into two groups, one contains instruction codes other than the NOP code and the other contains the NOP code. In the third embodiment, the instruction codes are grouped into a plurality of groups. The instruction output section 10 includes a decoding section 15, selectors 11-1 and 11-2, holding sections 12-1 and 12-2, and a buffer 13. In the third embodiment, the instruction code includes a first bit data and a second bit data, which contains a first bit portion and a second bit portion. In the third embodiment, there are difference instruction codes, in which the first bit data and the first bit portions are same but the second bit portions are different. For such a case, plural bits of the first bit data of the instruction code are decoded by the decoding section 15. The holding sections 12-1 and 12-2 hold first and second bit portions, respectively. The selector 11-1 receives the first bit portions from the instruction memory 20 and the holding section 12-1 and outputs a selected one of them to the holding section 12-1. The selector 11-2 receives the second bit portions from the instruction memory 20 and the holding section 12-2 and outputs a selected one of them to the holding section 12-2. The selectors 11-1 and 11-2 are controlled based on the decoding result of the decoding section 15. The first bit data from the instruction memory 20, the first bit portion selected by the selector 11-1 and the second bit portion selected by the selector 11-2 are outputted to the bus 1 through the buffer 13 as the instruction code. In this way, when the first instruction code and the second instruction code are different from each other in the second portion, the power consumption can be further reduced in the third embodiment.

What is claimed is:

1. An operation apparatus comprising:
signal lines;
a decoder connected with said signal lines and configured to sequentially decode first and second instruction codes on said signal lines;
an instruction executing section configured to execute operation processing based on each of the decoding results of said first and second instruction codes by said decoder, respectively; and
an output unit connected with said signal lines and configured to continuously and sequentially output said first and second instruction codes onto said signal lines,
wherein each of said first and second instruction codes comprises a first bit data and a second bit data,
said first bit data of said first instruction code indicates that said first instruction code belongs to a first one of instruction code groups and at least a portion of said second bit data of said first instruction code indicates an instruction content of said first instruction code, and
said first bit data of said second instruction code indicates that said second instruction code belongs to a second one of said instruction code groups and at least a portion of said second bit data of said second instruction code is same as that of said second bit data of said first instruction code.

2. The operation apparatus according to claim 1, wherein said output unit comprises:
a memory configured to store a plurality of original instruction codes,
wherein continuous two of said plurality of original instruction codes are sequentially outputted from said memory as first and second original instruction codes,
when said first original instruction code belongs to said first instruction code group, said first instruction code is outputted from said output unit onto said signal lines to have said first bit data and said second bit data of said first original instruction code, and
when said second original instruction code belongs to said second instruction code group, said second instruction code is outputted from said output unit onto said signal lines to have said first bit data of said second original instruction code and said second bit data of said first original instruction code.

3. The operation apparatus according to claim 2, wherein said first bit data is a 1-bit data,
said output unit comprises:
said memory;
a selector; and
a holding section configured to hold said second bit data outputted from said selector,
wherein said selector selects one of said second bit data of each of said plurality of original instruction codes from said memory and said second bit data held by said holding section in response to said first bit data of said each original instruction code from said memory, and outputs the selected second bit data to said holding section,
said selector selects said second bit data of said first original instruction code in response to said first bit data of said first original instruction code and outputs the selected second bit data to said holding section; and selects said second bit data held by said holding section in response to said first bit data of said second original instruction code and outputs the selected second bit data to said holding section, and
said first bit data of said first original instruction code and the selected second bit data are outputted to said signal lines as said first instruction code, and said first bit data of said second original instruction code and the selected second bit data are outputted to said signal lines as said second instruction code.

4. The operation apparatus according to claim 3, wherein said second original instruction code is a No Operation code.

5. The operation apparatus according to claim 1, wherein said output unit comprises:
a memory configured to store a plurality of instruction codes,
wherein continuous two of said plurality of instruction codes are sequentially outputted from said memory as first and second instruction codes.

6. The operation apparatus according to claim 1, wherein said second bit comprises a first bit portion and a second bit portion,
said output unit comprises:
a memory configured to store a plurality of original instruction codes,
wherein continuous two of said plurality of original instruction codes are sequentially outputted from said memory as first and second original instruction codes,
when said first original instruction code belongs to said first instruction code group, said first instruction code is outputted from said output unit onto said signal lines to have said first bit data, said first bit portion and said second bit portion of said first original instruction code, and
when said second original instruction code belongs to said second instruction code group, said second instruction code is outputted from said output unit onto said signal lines to have said first bit data and said first bit portion of said second original instruction code and said second bit portion of said first original instruction code.

7. The operation apparatus according to claim 6, wherein said first bit data is a plural bit data,
said output unit comprises:
said memory;
a decoding section configured to decode each of said plurality of original instruction codes;
first and second selectors; and
first and second holding section configured to hold said first and second bit potions outputted from said first and second selectors, respectively,
wherein said decoding section decodes said first bit data of each of said first and second original instruction codes,
said first selector selects one of said first bit portion of each of said plurality of original instruction codes from said memory and said first bit portion held by said first holding section in response to the decoding result of said first bit data of said original instruction code from said memory, and outputs the selected first bit portion to said first holding section,
said second selector selects one of said second bit portion of said original instruction code and said second bit portion held by said second holding section in response to the decoding result of said first bit data of said original instruction code, and outputs the selected second bit portion to said second holding section,
wherein said first selector selects said first bit portion of said first original instruction code in response to the decoding result of said first bit data of said first original instruction code and outputs the selected first bit portion to said first holding section; and selects said first bit portion of said second original instruction code in response to the decoding result of said first bit data of said second original instruction code and outputs the selected first bit portion to said first holding section,
said second selector selects said second bit portion of said first original instruction code in response to the decoding result of said first bit data of said first original instruction code and outputs the selected second bit portion to said second holding section; and selects said second bit portion held by said second holding section in response to said first bit data of said second original instruction code and outputs the selected second bit data to said second holding section, and
said first bit data and said first bit portion of said first original instruction code and the selected second bit portion are outputted to said signal lines as said first instruction code, and said first bit data and said first bit portion of said second original instruction code and the selected second bit portion are outputted to said signal lines as said second instruction code.

8. A method of executing instruction codes, comprising:
continuously and sequentially outputting first and second instruction codes onto signal lines;
decoding each of said first and second instruction codes on said signal lines; and
executing operation processing based on the decoding result of each of said first and second instruction codes,
wherein each of said first and second instruction codes comprises a first bit data and a second bit data,
said first bit data of said first instruction code indicates that said first instruction code belongs to a first one of instruction code groups and at least a portion of said second bit data of said first instruction code indicates an instruction content of said first instruction code, and
said first bit data of said second instruction code indicates that said second instruction code belongs to a second one of said instruction code groups and at least a portion of said second bit data of said second instruction code has a same second bit data as that of said second bit data of said first instruction code.

9. The method according to claim 8, wherein said continuously and sequentially outputting first and second instruction codes comprises:
outputting a plurality of original instruction codes from a memory, wherein continuous two of said plurality of original instruction codes are sequentially outputted from said memory as first and second original instruction codes;
outputting said first instruction code onto said signal lines to have said first bit data and said second bit data of said first original instruction code when said first original instruction code belongs to said first instruction code group; and
outputting said second instruction code onto said signal lines to have said first bit data of said second original instruction code and said second bit data of said first original instruction code when said second original instruction code belongs to said second instruction code group.

10. The method according to claim 9, wherein said first bit data is a 1-bit data,
said outputting said first instruction code comprises:
selecting said second bit data of said first original instruction code in response to said first bit data of said first original instruction code;
holding the selected second bit data of said first original instruction code; and
outputting said first bit data of said first original instruction code and the selected second bit data to said signal lines as said first instruction code, and
said outputting said second instruction code comprises:
selecting said held second bit data in response to said first bit data of said second original instruction code; and
outputting said first bit data of said second original instruction code and the selected second bit data to said signal lines as said second instruction code.

11. The method according to claim 10, wherein said second original instruction code is a No Operation code.

12. The method according to claim 8, wherein said continuously and sequentially outputting first and second instruction codes comprises:
storing a plurality of instruction codes in a memory; and
reading out continuous two of said plurality of instruction codes sequentially as first and second instruction codes.

13. The method according to claim 8, wherein said second bit comprises a first bit portion and a second bit portion,
said continuously and sequentially outputting first and second instruction codes comprises:
outputting a plurality of original instruction codes from a memory configured, wherein continuous two of said plurality of original instruction codes are sequentially outputted from said memory as first and second original instruction codes;
outputting said first instruction code onto said signal lines to have said first bit data, said first bit portion and said second bit portion of said first original instruction code, when said first original instruction code belongs to said first instruction code group; and
outputting said second instruction code onto said signal lines to have said first bit data and said first bit portion of said second original instruction code and said second bit portion of said first original instruction code, when said second original instruction code belongs to said second instruction code group.

14. The method according to claim 13, wherein said first bit data is a plural bit data,
said outputting said first instruction code comprises:
decoding said first bit data of said first original instruction code;
selecting said first bit portion of said first original instruction code in response to the decoding result of said first bit data of said first original instruction code;
selecting said second bit portion of said first original instruction code in response to the decoding result of said first bit data of said first original instruction code;
holding the selected first bit portion;
holding the selected second bit portion; and
outputting said first bit data and said first bit portion of said first original instruction code and the selected second bit portion to said signal lines as said first instruction code, and
said outputting said second instruction code comprises:
decoding said first bit data of said second original instruction code;
selecting said first bit portion of said second original instruction code in response to the decoding result of said first bit data of said second original instruction code;
selecting said held second bit portion held by said second holding section in response to said first bit data of said second original instruction code; and
outputting said first bit data and said first bit portion of said second original instruction code and the selected second bit portion onto said signal lines as said second instruction code.

15. A computer-readable software product containing codes for realizing a method of executing instruction codes, said method comprises:
continuously and sequentially outputting first and second instruction codes onto signal lines;
decoding each of said first and second instruction codes on said signal lines; and
executing operation processing based on the decoding result of each of said first and second instruction codes,
wherein each of said first and second instruction codes comprises a first bit data and a second bit data,
said first bit data of said first instruction code indicates that said first instruction code belongs to a first one of instruction code groups and at least a portion of said second bit data of said first instruction code indicates an instruction content of said first instruction code, and
said first bit data of said second instruction code indicates that said second instruction code belongs to a second one of said instruction code groups and at least a portion of said second bit data of said second instruction code has a same second bit data as that of said second bit data of said first instruction code.

16. The computer-readable software product according to claim 15, wherein said continuously and sequentially outputting first and second instruction codes comprises:
outputting a plurality of original instruction codes from a memory, wherein continuous two of said plurality of original instruction codes are sequentially outputted from said memory as first and second original instruction codes;
outputting said first instruction code onto said signal lines to have said first bit data and said second bit data of said first original instruction code when said first original instruction code belongs to said first instruction code group; and
outputting said second instruction code onto said signal lines to have said first bit data of said second original instruction code and said second bit data of said first original instruction code when said second original instruction code belongs to said second instruction code group.

17. The computer-readable software product according to claim 16, wherein said first bit data is a 1-bit data,
said outputting said first instruction code comprises:
selecting said second bit data of said first original instruction code in response to said first bit data of said first original instruction code;
holding the selected second bit data of said first original instruction code; and
outputting said first bit data of said first original instruction code and the selected second bit data to said signal lines as said first instruction code, and
said outputting said second instruction code comprises:
selecting said held second bit data in response to said first bit data of said second original instruction code; and
outputting said first bit data of said second original instruction code and the selected second bit data to said signal lines as said second instruction code.

18. The computer-readable software product according to claim 15, wherein said second bit comprises a first bit portion and a second bit portion,
said continuously and sequentially outputting first and second instruction codes comprises:
outputting a plurality of original instruction codes from a memory configured, wherein continuous two of said plurality of original instruction codes are sequentially outputted from said memory as first and second original instruction codes;
outputting said first instruction code onto said signal lines to have said first bit data, said first bit portion and said second bit portion of said first original instruction code, when said first original instruction code belongs to said first instruction code group; and
outputting said second instruction code onto said signal lines to have said first bit data and said first bit portion of said second original instruction code and said second bit portion of said first original instruction code, when said second original instruction code belongs to said second instruction code group.

19. The computer-readable software product according to claim 18, wherein said first bit data is a plural bit data,
said outputting said first instruction code comprises:
decoding said first bit data of said first original instruction code;
selecting said first bit portion of said first original instruction code in response to the decoding result of said first bit data of said first original instruction code;
selecting said second bit portion of said first original instruction code in response to the decoding result of said first bit data of said first original instruction code;
holding the selected first bit portion;
holding the selected second bit portion; and
outputting said first bit data and said first bit portion of said first original instruction code and the selected second bit portion to said signal lines as said first instruction code, and
said outputting said second instruction code comprises:
decoding said first bit data of said second original instruction code;
selecting said first bit portion of said second original instruction code in response to the decoding result of said first bit data of said second original instruction code;
selecting said held second bit portion held by said second holding section in response to said first bit data of said second original instruction code; and
outputting said first bit data and said first bit portion of said second original instruction code and the selected second bit portion onto said signal lines as said second instruction code.
